(19) United States
(12) Patent Application Publication
(10) Pub. No.: US 2002/0085171 A1
(43) Pub. Date: Jul. 4, 2002

(54) Eyeglass frame with tilt-adjustable bows

(76) Inventor: Min-Young Wang -Lee, Taiwan (CN)

Correspondence Address: OSTROLENK FABER GERB & SOFFEN, 1180 AVENUE OF THE AMERICAS, NEW YORK, NY, 100368403

(21) Appl. No.: 09/810,632

(22) Filed: Mar. 16, 2001

(30) Foreign Application Priority Data
Jan. 2, 2001 (CN) 090200051

(51) Int. Cl. G02C 5/14

(52) U.S. Cl. 351/120; 351/121

(57) ABSTRACT

An eyeglass frame includes a lens member with a pair of lateral wing portions, each of which has a pivot hole and a resilient piece formed between the pivot hole and a rear edge section of the wing portion. The resilient piece has an engaging protrusion. Each of a pair of connectors is formed with a horizontal pivot shaft which extends rotatably through the pivot hole in a respective wing portion. Each connector has a rear end portion formed with a clamping space for clamping the rear edge section of the respective wing portion, and is formed with a series of engaging grooves which are arranged in a direction from an upper end to a lower end of the connector. The engaging protrusion on the resilient piece engages resiliently and removably a selected one of the engaging grooves in a corresponding connector so as to permit adjustment of tilt of the connector relative to the respective wing portion. The rear end portion of each connector is connected pivotally to a respective bow such that the bow is pivotable about a vertical axis for folding toward and unfolding from the lens member.

### BACKGROUND OF THE INVENTION

1. Field of the Invention

The present invention relates to an eyeglass frame, more particularly to an eyeglass frame which includes tilt-adjustable bows.

2. Description of the Related Art

FIG. 1 illustrates a conventional eyeglass frame 1 with tilt-adjustable bows 13. The conventional eyeglass frame 1 includes a lens member 11 formed integrally with a pair of lens portions 111 and two opposite wing portions 112 which extend rearwardly and respectively from two opposite lateral sides of the lens portions 111. Each wing portion 112 is formed with a curved slot 14 which extends in a generally vertical direction, and which is composed of a plurality of intercommunicated round slot portions 145. Each wing portion 112 is further formed with a pivot recess 113 at a rear edge thereof. A pair of connectors 12 are mounted respectively on the wing portions 112. Each connector 12 has an engaging protrusion 123 formed on a front end 121 thereof for extension through the curved slot 14, a pivot lobe 125 projecting from a rear end thereof for connecting pivotally with a respective one of the bows 13, and a pivot block 122 formed between the engaging protrusion 123 and the pivot lobe 125 for engaging the pivot recess 113. As shown in FIG. 2, the engaging protrusion 123 has an elongated stop plate 124 formed on a distal end thereof for engaging an inner side surface of the adjacent wing portion 112. Referring to FIG. 3, to adjust the tilt of the bows 13, each of the bows 13 is moved upwardly and downwardly to cause pivoting movement of the front end 121 of the respective connector 12 about a horizontal axis of the corresponding pivot recess 113 so as to enable the engaging protrusion 123 to move along the curved slot 14 for engaging a selected one of the round slot portions 145, thereby retaining the respective bow 13 at a desired tilt relative to the lens member 11.

However, since each of the round slot portions 145 in each slot 14 is formed to have a size sufficient to retain the engaging protrusion 123, the slot 14 can only include a relatively limited number of the round slot portions 145, and fine adjustment in the tilting angle of the bows 13 is not allowed. Moreover, frequent movement of the engaging protrusions 123 along the curved slots 14 during use of the eyeglass frame 1 may result in wearing of peripheral walls of the slots 14, thereby weakening the engagement between the engaging protrusions 123 and the selected slot portions 145.

### SUMMARY OF THE INVENTION

Therefore, the main object of the present invention is to provide an eyeglass frame which permits fine adjustment in the tilt of bows.

Accordingly, the eyeglass frame of the present invention includes a lens member, a pair of connectors and a pair of elongated bows. The lens member has a pair of lens portions which face forward, and a pair of lateral wing portions disposed respectively on opposite lateral sides of the lens portions and extending rearwardly from the lens portions. Each of the wing portions has a rear edge section, a pivot hole formed therethrough and disposed in front of the rear edge section, and a resilient piece formed between the pivot hole and the rear edge section. The resilient piece has an engaging protrusion. Each of the connectors has upper and lower ends, a front end portion formed with a horizontal pivot shaft which extends rotatably through the pivot hole in a respective one of the wing portions such that the connector is pivotable relative to the respective one of the wing portions about an axis of the pivot hole in the respective one of the wing portions. The connector further has a rear end portion formed with a clamping space which opens forwardly for clamping the rear edge section of the respective one of the wing portions, and an intermediate portion between the front and rear end portions. The intermediate portion is formed with a series of engaging grooves which are arranged in a direction from the upper end to the lower end of the connector. The engaging protrusion of the resilient piece on each of the wing portions engages resiliently and removably a selected one of the engaging grooves in a corresponding one of the connectors so as to permit adjustment of tilt of the connector relative to the respective wing portion. Each of the elongated bows is connected pivotally to the rear end portion of a respective one of the connectors so as to be pivotable about a vertical axis for folding toward and unfolding from the lens member.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view of a conventional eyeglass frame with tilt-adjustable bows;

FIG. 2 is fragmentary sectional view of the conventional eyeglass frame;

FIG. 3 is a fragmentary schematic view of the conventional eyeglass frame, illustrating operations for adjusting tilt of the bows;

FIG. 4 is an exploded perspective view illustrating a preferred embodiment of the eyeglass frame according to the present invention;

FIG. 5 is a fragmentary sectional top view of the preferred embodiment; and

FIGS. 6 and 7 are schematic side views of the preferred embodiment, illustrating operations for adjusting tilt of a bow of the eyeglass frame.

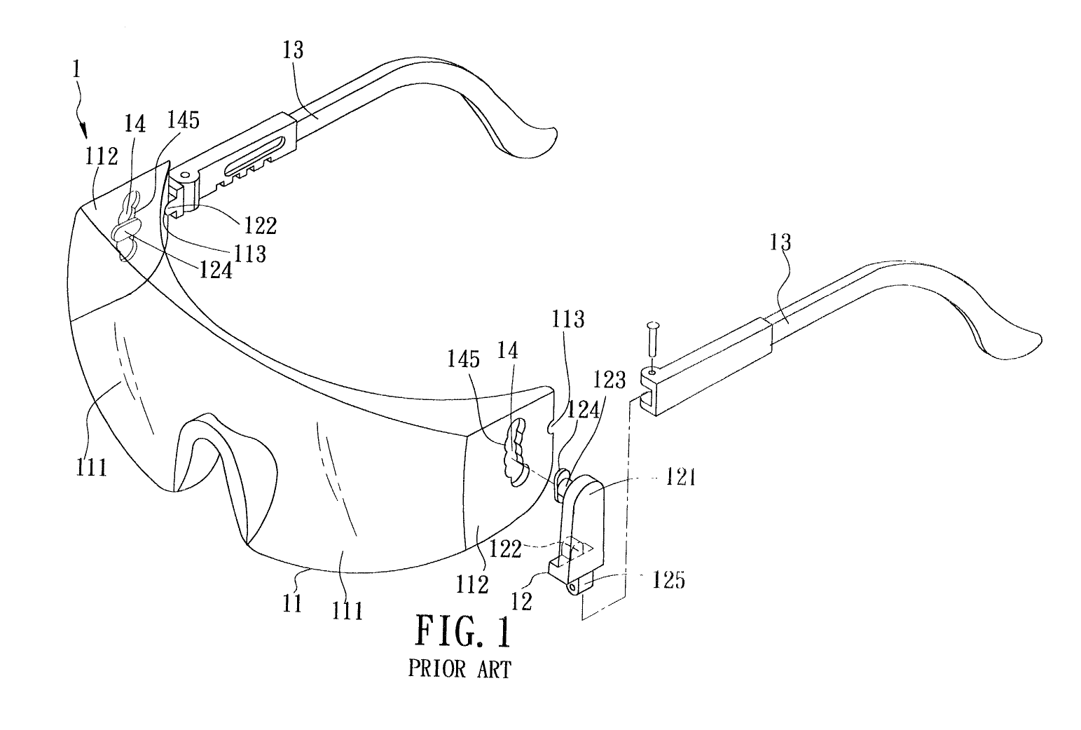

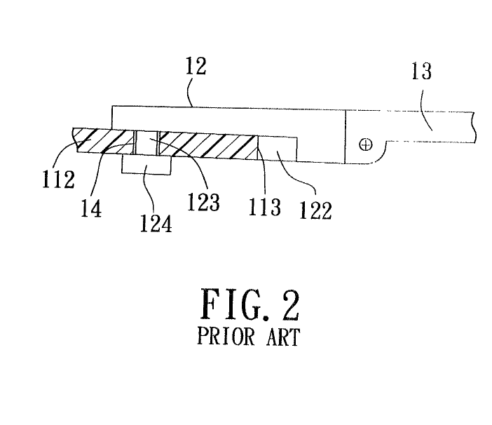

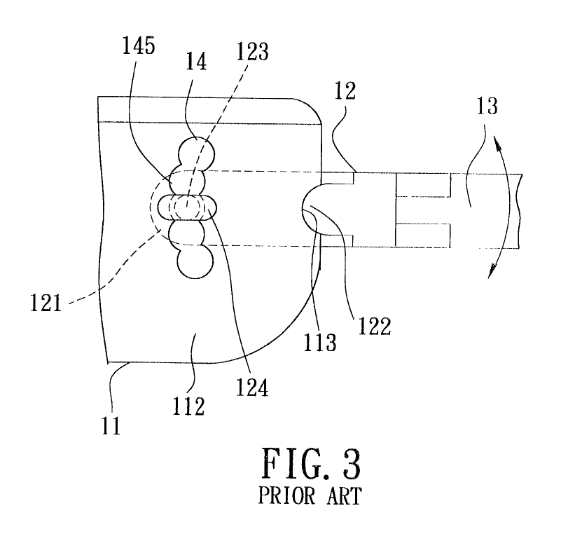

### DETAILED DESCRIPTION OF THE PREFERRED EMBODIMENTS

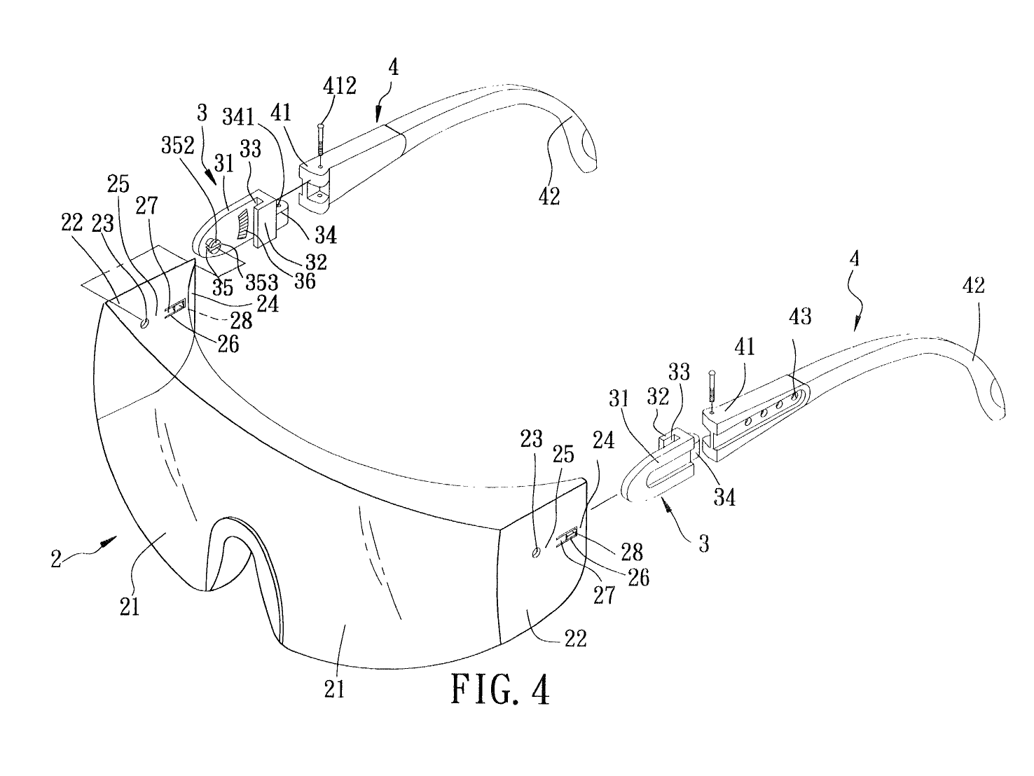

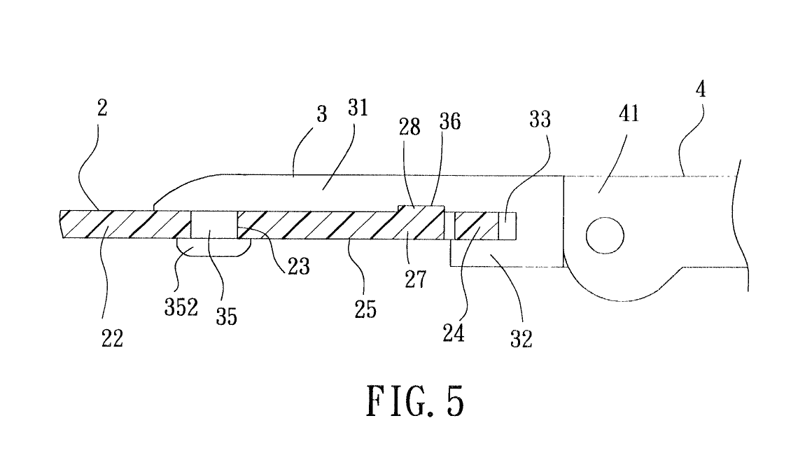

Referring to FIGS. 4 and 5, the preferred embodiment of the eyeglass frame of the present invention is shown to include a lens member 2, a pair of connectors 3, and a pair of elongated bows 4. The lens member 2, preferably an integrally formed lens piece, includes a pair of lens portions 21 that face forwardly, and a pair of wing portions 22 disposed respectively on two opposite lateral sides of the lens portions 21 and extending rearwardly from the lens portions 21. Each of the wing portions 22 has a rear edge section 24, a pivot hole 23 formed therethrough and disposed in front of the rear edge section 24, and a mounting section 25 between the pivot hole 23 and the rear edge section 24. The mounting section 25 is formed with a U-shaped slit 26 so as to define an elongated resilient piece 27 therein. The resilient piece 27 has a front end connected integrally to the respective wing portion 22 and a distal rear end formed with an elongated engaging protrusion 28 which projects from an outer side surface of the respective wing portion 22. The resilient piece 27 extends along a generally horizontal line that passes through the pivot hole 23. The engaging protrusion 28 has a triangular cross-section, and extends along the length of the resilient piece 27.

Each of the connectors 3 has a mounting plate 31 which is disposed adjacent to a respective one of the wing portions 22, and which has an inner side surface confronting the outer side surface of the respective wing portion 22. The inner side surface of the mounting plate 31 is formed with a pivot shaft 35 at a front end portion thereof, and a series of elongated engaging grooves 36 between the front end portion and a rear end portion thereof for engaging the engaging protrusion 28 of the resilient piece 27 on the adjacent wing portion 22. The engaging grooves 36 in a respective one of the connectors 3 are disposed immediately adjacent to one another and extend along radial directions that radiate from an axis of the pivot shaft 35 such that the engaging grooves 36 are arranged along a curved line and cooperatively form a fan-shaped pattern on the inner side surface of the respective connector 3. The pivot shaft 35 has an enlarged head portion 352, and is formed with a slot 353 which extends along an axis of the pivot shaft 35 for dividing the pivot shaft 35 into two separate half-parts and which imparts resiliency to the pivot shaft 35. The two half-parts of the pivot shaft 35 are forced close to each other so as to enable the enlarged head portion 352 to pass through the pivot hole 23 in the respective wing portion 22 when the pivot shaft 35 is extended through the pivot hole 23, and spring back away from each other after extension of the pivot shaft 35 through the pivot hole 23 to enable the head portion 352 to engage an inner side surface of the respective wing portion 22. An L-shaped clamping plate 32 is connected integrally to the rear end portion of the mounting plate 31, and extends forwardly so as to cooperate with the mounting plate 31 to define a clamping space 33 at a rear end portion of the connector 3. The clamping space 33 opens forwardly and opens in upper and lower ends of the connector 3 for clamping the rear edge portion 24 of the respective wing portions 22. Each of the connectors 3 further has a pivot lobe 34 which projects from the rear end portion thereof and which is formed with a vertically extending pivot hole 341.

Each of the bows 4 has a front end portion 41 mounted pivotally to the pivot lobe 34 by means of a vertical pivot pin 412 such that the bows 4 are pivotable about vertical axes for folding toward and unfolding from the lens member 2. Each of the bows 4 further has a curved rear end portion 42 adapted to be hung on an ear of the user. Optionally, a length-adjusting unit 43 is provided between the front and rear end portions 41, 42 of each of the bows 4 to permit adjustment of the length of the bows 4. Since the present invention is not characterized in the length-adjusting unit 43, a detailed description thereof is omitted herein for the sake of brevity.

In assembly, the bows 4 are assembled to the pivot lobes 34 on the rear end portions of the connectors 3 for connecting pivotally thereto. Thereafter, each of the connectors 3 is assembled to a respective one of the wing portions 22 by extending the pivot shaft 35 through the pivot hole 23 in the respective wing portion 22 and by extending the rear edge section 24 of the respective wing portion 22 into the clamping space 33 of the connector 3 such that the engaging protrusion 28 on the respective wing portion 22 engages resiliently and removably a selected one of the engaging grooves 36 in the connector 3.

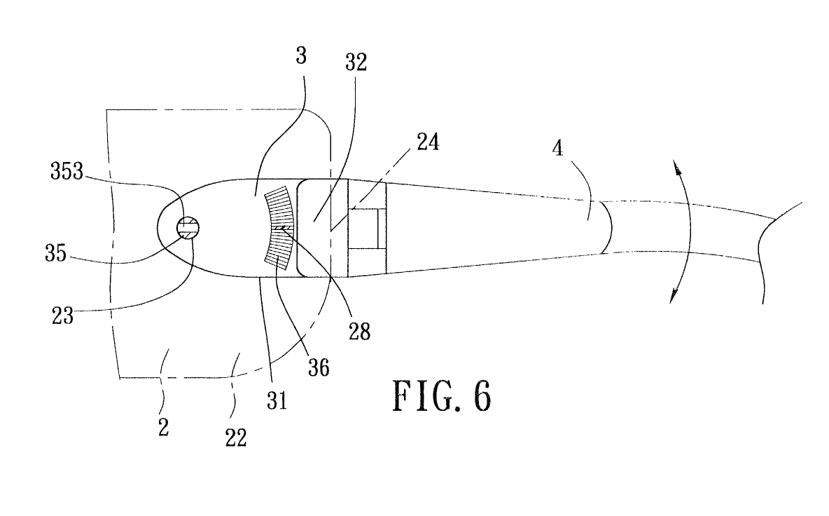

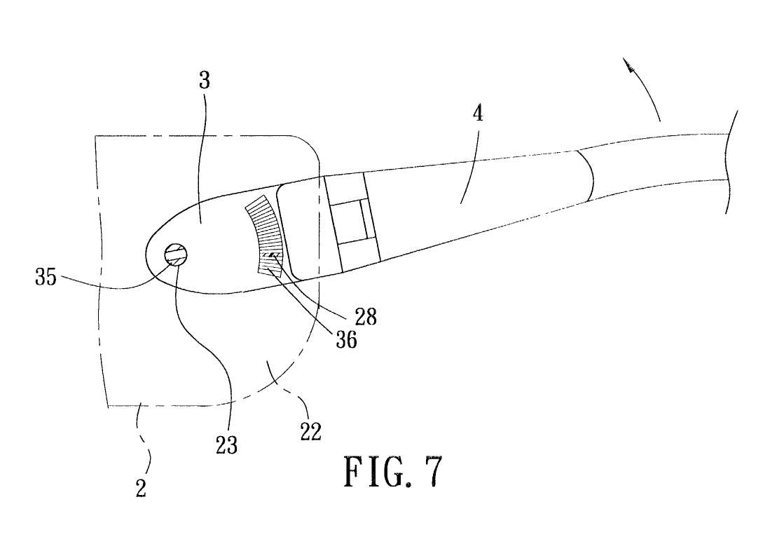

Referring to FIGS. 6 and 7, to adjust the tilt of the bows 4 relative to the lens member 2, each of the bows 4 is moved upwardly and downwardly for pivoting about a horizontal axis of the pivot hole 23 in the respective one of the wing portions 22 to permit the engaging protrusion 28 of the resilient piece 27 on the respective wing portion 22 to move among the engaging grooves 36 for engaging a selected one of the engaging grooves 36 so as to dispose the bow 4 at a desired tilt relative to the respective wing portion 22.

In another embodiment, the resilient pieces that are formed with the engaging protrusions may be formed on the connectors, while the engaging grooves maybe formed on the wing portions to achieve a similar tilt adjustment effect.

In still another embodiment, the engaging grooves in a respective one of the connectors may extend along parallel horizontal directions and may be arranged along a vertical direction on the respective connector to simplify manufacturing process of the connector. In this case, at least distal ones of the engaging grooves are formed to have a width wider than that of the engaging protrusion and sufficient to accommodate the engaging protrusion therein since the distal ones of the engaging grooves would be inclined relative to radial lines of the pivot axis of the pivot hole in the respective wing portion.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An eyeglass frame comprising:
a lens member having a pair of lens portions which face forward, and a pair of lateral wing portions disposed respectively on opposite lateral sides of said lens portions and extending rearwardly from said lens portions, each of said wing portions having a rear edge section, a pivot hole formed therethrough and disposed in front of said rear edge section, and a resilient piece formed between said pivot hole and said rear edge section, said resilient piece having an engaging protrusion;
a pair of connectors, each of which has upper and lower ends, a front end portion formed with a horizontal pivot shaft which extends rotatably through said pivot hole in a respective one of said wing portions such that said connector is pivotable relative to the respective one of said wing portions about an axis of said pivot hole, each of said connectors further having a rear end portion formed with a clamping space which opens forwardly for clamping said rear edge section of the respective one of said wing portions, and an intermediate portion between said front and rear end portions, said intermediate portion being formed with a series of engaging grooves which are arranged in a direction from said upper end to said lower end of said connector, said engaging protrusion of said resilient piece on each of said wing portions engaging resiliently and removably a selected one of said engaging grooves in an adjacent one of said connectors so as to permit adjustment of tilt of said connector relative to the respective wing portion; and
a pair of elongated bows, each of which is connected pivotally to said rear end portion of a respective one of said connectors so as to be pivotable about a vertical axis for folding toward and unfolding from said lens member.

2. The eyeglass frame as claimed in claim 1, wherein said engaging protrusion on said resilient piece of each of said wing portions is elongated and extends in a radial direction radiating from the axis of said pivot hole, each of said engaging grooves in each of said connectors being elongated in shape.

3. The eyeglass frame as claimed in claim 2, wherein said engaging grooves in each of said connectors extend along radial lines radiating from an axis of said pivot shaft of the respective one of said connectors.

4. The eyeglass frame as claimed in claim 1, wherein each of said wing portions has an outer side surface opposite to the other one of said wing portions, said engaging protrusion on said resilient piece projecting from said outer side surface of the respective one of said wing portions, each of said connectors having a mounting plate which has a front end portion formed with said pivot shaft and which is disposed adjacent to said outer side surface of the respective one of said wing portions, said mounting plate further having an inner side surface which confronts said outer side surface of the respective wing portion and which is formed with said engaging grooves.

5. The eyeglass frame as claimed in claim 4, wherein each of said connectors further has an L-shaped clamping plate connected to said rear end portion of said mounting plate so as to cooperate with said mounting plate to define said clamping space.

6. An eyeglass frame comprising:
a lens member having a pair of lens portions which face forward, and a pair of lateral wing portions disposed respectively on opposite lateral sides of said lens portions and extending rearwardly from said lens portions;
a pair of elongated bows;
a pair of connectors for connecting said bows to said wing portions respectively such that said bows are pivotable about vertical axes for folding toward and unfolding from said lens member; and
an adjustment mechanism provided on said wing portions and said connectors, said adjustment mechanism including a pivot unit for mounting said connectors pivotally on said wing portions such that each of said connectors is pivotable relative to a respective one of said wing portions about a horizontal pivot axis, said adjustment mechanism further including a series of elongated engaging grooves arranged in a vertical direction, and a resilient piece that is formed with an engaging protrusion for engaging resiliently and removably a selected one of said engaging grooves so as to permit adjustment of tilt of said bows relative to said wing portions.
